(19) United States
(12) Patent Application Publication
(10) Pub. No.: US 2017/0166839 A1
(43) Pub. Date: Jun. 15, 2017

(54) LIQUID LAUNDRY DETERGENT COMPOSITION

(71) Applicant: The Procter & Gamble Company, Cincinnati, OH (US)

(72) Inventors: Lucia FERNANDEZ MARTINEZ, Brussels (BE); Nigel Patrick SOMERVILLE ROBERTS, Newcastle upon Tyne (GB); Alan Thomas BROOKER, Newcastle upon Tyne (GB)

(21) Appl. No.: 15/372,432

(22) Filed: Dec. 8, 2016

(30) Foreign Application Priority Data
Dec. 10, 2015 (EP) 15199372.2
Nov. 1, 2016 (EP) 16196749.2

(51) Int. Cl. C11D 3/22; C11D 1/02; C11D 17/04; C11D 3/20; C11D 17/06; C11D 11/00

(52) U.S. Cl. CPC C11D 3/222; C11D 17/06; C11D 11/0017; C11D 17/042; C11D 17/045; C11D 3/2065; C11D 1/02

(57) ABSTRACT

A liquid laundry detergent composition comprising a first polymer in particulate form and a second polymer, optionally in particulate form. Related water-soluble unit dose articles.

### FIELD OF THE INVENTION

The present disclosure relates to a liquid laundry detergent composition comprising a first polymer in particulate form and a second polymer, optionally in particulate form.

### BACKGROUND OF THE INVENTION

Liquid laundry detergent compositions comprising low levels of water are useful for use in water-soluble unit dose articles. However, a certain level of water is required in order to maintain the correct degree of plasticization of the film.

Regulation of the water level can become problematic when ingredients are formulated into the composition which have a tendency to bind water, for example polymers. Firstly, there is a tendency for the liquid composition to suffer from increased viscosity due to the polymer/water interaction. This problem can be exacerbated wherein polymers of opposite charges are present. The interaction of the oppositely charged polymers with on another further serves to increase the viscosity of the liquid composition. This increase in viscosity can cause problems during use, such as difficulty in pouring, and also issues during manufacture in which the viscosity of compositions to which the polymers are added increases to unmanageable levels.

Secondly, the reduced availability of water in the liquid composition can negatively affect the plasticization and hence stability of the film. This can lead to unwanted premature rupture of the film.

Therefore, there is a need in the art for a low water liquid laundry detergent composition suitable for use in a water-soluble unit dose article comprising oppositely charged polymers and which exhibits an acceptable rheological profile.

It was surprisingly found that the liquid laundry detergent composition of the present invention overcame this technical problem.

### SUMMARY OF THE INVENTION

The present disclosure relates to a high active polymer composition suitable for incorporation into a water-soluble unit dose article, wherein the high active polymer composition comprises less than 15wt % water, an alcohol, a first polymer and a second polymer, wherein the first polymer is in particulate form, and wherein the second polymer is optionally in particulate form, and wherein the first polymer has an overall anionic charge and comprises an alkali metal ion, an amine, ammonium ion or a mixture thereof, and wherein the second polymer has an overall cationic charge and comprises a halogen ion; wherein the alcohol is selected from the group comprising ethylene glycol, tetramethylene glycol, pentamethylene glycol, hexamethylene glycol, 2,3-butane diol, 1,3 butanediol, diethylene glycol, triethylene glycol, polyethylene glycol having a molecular weight of less than 6000, glycerol formal, dipropylene glycol, dipropylene glycol methyl ether, propylene glycol monopropyl ether, tripropylene glycol, polypropylene glycol, dipropylene glycol n-butyl ether, and mixtures thereof, preferably the alcohol is selected from the group comprising dipropylene glycol methyl ether, dipropylene glycol, polypropylene glycol, 2,3-butane diol, dipropylene glycol n-butyl ether and mixtures thereof.

The present disclosure also relates to a water-soluble unit dose article comprising a water-soluble film and a high active polymer composition according to the present invention.

### DETAILED DESCRIPTION OF THE INVENTION

### High Active Polymer Composition

The present disclosure relates to a high active polymer composition suitable for incorporation into a water-soluble unit dose article comprising less than 15wt % water, an alcohol, a first polymer and a second polymer. The term ‘high active’ herein means that the concentration of polymer present is higher than would normally be used in a commercially available laundry detergent composition. In other words the high active polymer composition is meant to serve as an intermediate composition in the production of a final commercially relevant laundry detergent composition.

The high active polymer composition may be in any suitable form. The high active polymer composition may be a liquid, a solid, or a mixture thereof. The term ‘liquid laundry detergent composition’ refers to any laundry detergent composition comprising a liquid capable of wetting and treating fabric e.g., cleaning clothing in a domestic washing machine, and includes, but is not limited to, liquids, gels, pastes, dispersions and the like. The liquid composition can include solids or gases in suitably subdivided form, but the liquid composition excludes forms which are non-fluid overall, such as tablets or granules.

The high active polymer composition may be formulated into a unit dose article. The unit dose article of the present invention comprises a water-soluble film which fully encloses the high active polymer composition in at least one compartment. Suitable unit dose articles are described in more detail below.

The high active polymer composition can be used as a fully formulated consumer product, or may be added to one or more further ingredient to form a fully formulated consumer product, preferably a liquid laundry detergent composition. The high active polymer composition may be a ‘pre-treat’ composition which is added to a fabric, preferably a fabric stain, ahead of the fabric being added to a wash liquor.

The high active polymer composition can be used in a fabric hand wash operation or may be used in an automatic machine fabric wash operation.

The first polymer, the second polymer or both may be comprised within a particle and wherein the particle comprises between 50% and 100%, preferably between 65% and 95% by weight of the particle of the polymer.

The composition may have an average particle size distribution d50 of between 30 um and 80 um, preferably between 40 um and 60 um and an average particle size distribution d90 of between 95 um and 140 um, preferably between 100 um and 125 um.

The first polymer, second polymer or both may be polysaccharide-based polymers.

The first polymer is in particulate form and is described in more detail below.

Preferably, the high active polymer composition comprises between 10% and 30%, preferably between 15% and 25% by weight of the composition of the second polymer. The second polymer is described in more detail below.

Preferably, the weight ratio of the second polymer to the first polymer is between 1:0.7 and 1:2, more preferably between 1:1 to 1:1.5.

Preferably, the high active polymer composition comprises between 40% and 70%, preferably between 50% and 65% by weight of the composition of the alcohol. The alcohol is described in more detail below.

Without wishing to be bound by theory, it is believed that carefully balancing the water and alcohol levels in the composition maintains the polymers in particulate form. In particulate form they do not dissolve and/or interact with one another so maintaining an acceptable rheology. Furthermore, the relevant water level is left available for the plasticization of the film and also the careful choice of the alcohol does not cause any negative impact on the film.

It was also surprisingly found that the composition of the present invention exhibited improved dispersion in the wash liquor.

In one aspect the present invention does not comprise a hydrophobically modified hydroxyethylcellulose, a carboxymethyl cellulose or a mixture thereof.

### First Polymer

The first polymer is in particulate form. By ‘particulate form’ we herein mean the first particle exists as a solid in the high active polymer composition. The solid can be in the form of discrete particles or in the form of a solid ‘block’, such as a compressed tablet. In the context of the present invention, a solid is any material that appears as a separate fraction to that of the liquid fraction upon centrifugation of the composition, preferably at at 1200 G for 10 mins using Sigma Centrifuge 6-15H, 6-pot rotor. The high active polymer composition may be liquid overall and the first polymer is a particle dispersed in the liquid.

The first polymer may be comprised within a particle. The particle may comprise between 50% and 100%, preferably between 65% and 95% by weight of the particle of the first polymer.

The particle may comprise a carrier. Preferably the carrier is selected from sulphate, carbonate, clay, starch, sugars, polyethylene glycol having a molecular weight of at least 8000 or a mixture thereof. Wherein the particle comprises a carrier, the first polymer is comprised within the carrier, on the carrier, or a mixture thereof.

The first polymer has an overall anionic charge. By overall anionic charge we herein mean that the polymer exhibits a positive zeta potential, preferably +5mV or higher. The zeta-potential is the apparent electrostatic potential generated by the polymer in solution. Those skilled in the art will know how to measure the zeta potential. Preferably, the Zeta-potential of the polymer is measured by the so-called phase analysis light scattering method, preferably using a ZetaPALS instrument (ex Brookhaven Instruments Corporation), wherein the polymer is present deionized water.

The first polymer comprises an alkali metal ion, an amine, ammonium ion or a mixture thereof. The alkali metal ion may be selected from potassium, sodium, magnesium or a mixtures thereof.

The first polymer maybe selected from polysaccharide-based polymers, polyester terephthalate polymers, polyethylene glycol based polymers or a mixture thereof.

In one aspect the first polymer may be selected from carboxymethylcellulose. The carboxymethyl cellulose may have a degree of carboxymethyl substitution from 0.5 to 0.9 and a molecular weight from 100,000 Da to 300,000 Da.

The carboxymethyl cellulose may have a degree of substitution (DS) of from 0.01 to 0.99 and a degree of blockiness (DB) such that either DS+DB is of at least 1.00 or DB+2DS−DS² is at least 1.20. The substituted carboxymethyl cellulose can have a degree of substitution (DS) of at least 0.55. The carboxymethyl cellulose can have a degree of blockiness (DB) of at least 0.35. The substituted cellulosic polymer can have a DS+DB, of from 1.05 to 2.00.

The first polymer may comprise a polyester terephthalate backbone grafted with one or more anionic groups. Suitable polymers have a structure as defined by one of the following structures (I), (II) or (III):

(I) —[(OCHR¹—CHR²)ₐ—O—OC—Ar—CO—]_{d}

(II) —[(OCHR³—CHR⁴)_{b}—O—OC-sAr—CO—]ₑ

(III) —[(OCHR⁵—CHR⁶)_{c}—OR⁷]_{f}

wherein:

a, b and c are from 1 to 200;

d, e and f are from 1 to 50 preferably from 2 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

The first polymer may be a polyethylene glycol based polymer. Polyethylene glycol polymers are those which comprise a polyethylene glycol. Preferably, the polymer backbone comprises the polyethylene glycol and the backbone further comprises side-chains grafted onto said polyethylene glycol backbone. Most preferably, the polyethylene glycol polymer comprises a polyethylene glycol backbone and hydrophobic sidechains. Preferred hydrophobic sidechains are selected from polyvinyl acetate, polyvinyl alcohol and mixtures thereof. Preferably, the polymer comprises from 25% to 60% by weight of the polymer of the backbone.

### Second Polymer

The second polymer is optionally in particulate form. By ‘particulate form’ we herein mean the second particle exists as a solid in the high active polymer composition. The high active polymer composition may be liquid overall and the second polymer is a particle dispersed in the liquid. Alternatively the second polymer may be a liquid.

The second polymer may be comprised within a particle. The particle may comprise between 50% and 100%, preferably between 65% and 95% by weight of the particle of the second polymer.

The particle may comprise a carrier. Preferably the carrier is selected from sulphate, carbonate, clay, starch, sugars, polyethylene glycol or a mixture thereof. Wherein the particle comprises a carrier, the second polymer is comprised within the carrier, on the carrier, or a mixture thereof.

The second polymer has an overall cationic charge. By overall cationic charge we herein mean that the polymer exhibits a negative zeta potential, preferably −5 mV or lower. The zeta-potential is the apparent electrostatic potential generated by the polymer in solution. Those skilled in the art will know how to measure the zeta potential. Preferably, the Zeta-potential of the polymer is measured by the so-called phase analysis light scattering method, preferably using a ZetaPALS instrument (ex Brookhaven Instruments Corporation), wherein the polymer is present deionized water.

The second polymer comprises a halogen ion, preferably chloride.

The second polymer may be a polysaccharide-based polymer.

The second polymer may comprise a hydroxyethylcellulose.

The hydroxyethylcellulose may comprise a hydrophobically modified hydroxyethylcellulose. By ‘hydrophobically modified’, we herein mean that one or more hydrophobic groups are bound to the polymer backbone. The hydrophobic group may be bound to the polymer backbone via an alkylene group, preferably a C₁₋₆ alkylene group.

Preferably, the hydrophobic group is selected from linear or branched alkyl groups, aromatic groups, polyether groups, or a mixture thereof.

The hydrophobic group may comprise an alkyl group. The alkyl group may have a chain length of between C₈ and C₅₀, preferably between C₈ and C₂₆, more preferably between C₁₂ and C₂₂, most preferably between C₁₆ and C₂₀.

The hydrophobic group may comprise a polyalkylene glycol, preferably wherein the polalkylene glycol is selected from polyethylene glycol, polypropylene glycol, or a mixture thereof. The polyethylene glycol may comprise a copolymer comprising oxyethylene and oxypropylene units. The copolymer may comprise between 2 and 30 repeating units, wherein the terminal hydroxyl group of the polyalkylene glycol is preferably esterified or etherized. Preferably, the ester bond is formed with an acid selected from a C₅₋₅₀ carboxylic acid, preferably C₈₋₂₆ carboxylic acid, more preferably _{C16-20} carboxylic acid, and wherein the ether bond is preferably formed with a C₅₋₅₀ alcohol, more preferably C₈₋₂₆ alcohol, most preferably a C₁₆₋₂₀ alcohol.

The hydroxyethyl cellulose may be derivatised with trimethyl ammonium substituted epoxide. The polymer may have a molecular weight of between 100,000 and 800,000 daltons.

The hydroxyethyl cellulose may have repeating substituted anhydroglucose units that correspond to the general Structural Formula I as follows:

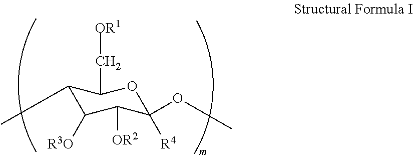

wherein:
a. m is an integer from 20 to 10,000
b. Each R4 is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

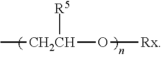

Preferably, R¹, R², R³ are each independently selected from the group consisting of: H;

C₁-C₄ alkyl;

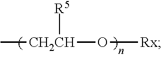

and mixtures thereof;

wherein:

n is an integer selected from 0 to 10 and

Rx is selected from the group consisting of: H;

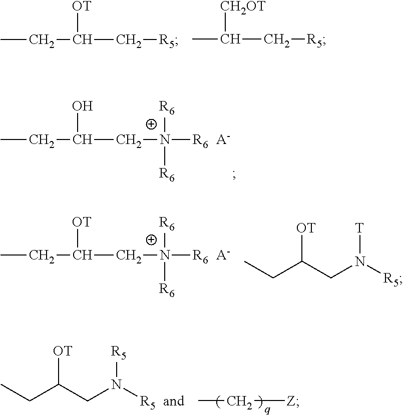

preferably Rx has a structure selected from the group consisting of: H;

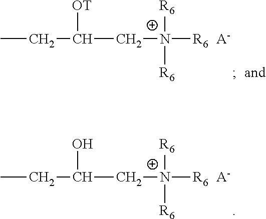

wherein A⁻ is a suitable anion. Preferably, A⁻ is selected from the group consisting of: Cl⁻, Br⁻, I⁻, methylsulfate, ethylsulfate, toluene sulfonate, carboxylate, and phosphate;

Z is selected from the group consisting of carboxylate, phosphate, phosphonate, and sulfate.

q is an integer selected from 1 to 4;

each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH. Preferably, each R₅ is selected from the group consisting of: H, C₁-C₃₂ alkyl, and C₁-C₃₂ substituted alkyl. More preferably, R₅ is selected from the group consisting of H, methyl, and ethyl.

Each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl. Preferably, each R₆ is selected from the group consisting of: H, C₁-C₃₂ alkyl, and C₁-C₃₂ substituted alkyl.

Each T is independently selected from the group:

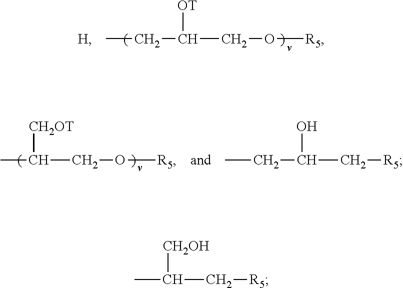

wherein each v in said polysaccharide is an integer from 1 to 10. Preferably, v is an integer from 1 to 5. The sum of all v indices in each Rx in said polysaccharide is an integer from 1 to 30, more preferably from 1 to 20, even more preferably from 1 to 10. In the last

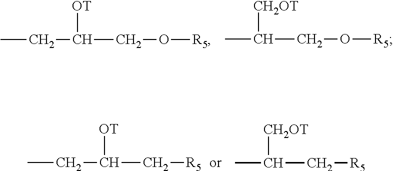

group in a chain, T is always an H.

Alkyl substitution on the anhydroglucose rings of the polymer may range from 0.01% to 5% per glucose unit, more preferably from 0.05% to 2% per glucose unit, of the polymeric material.

The hydroxyethylcellulose may be lightly cross-linked with a dialdehyde, such as glyoxal, to prevent forming lumps, nodules or other agglomerations when added to water at ambient temperatures.

The polymers of Structural Formula I likewise include those which are commercially available and further include materials which can be prepared by conventional chemical modification of commercially available materials. Commercially available cellulose polymers of the Structural Formula I type include those with the INCI name Polyquaternium 10, such as those sold under the trade names: Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name: Celquat H200 and Celquat L-200, available from National Starch and Chemical Company, Bridgewater, N.J. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J.

### Alcohol

The alcohol has a molecular weight of between 20 and 400 and an eRH of between 70% and 100% preferably between 75% and 98% at 20° C. as measured via the alcohol eRH test described herein.

The alcohol eRH test comprises the steps of preparing a solution of 80% alcohol in deionised water, followed by adding this to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

By ‘alcohol’ we herein mean either a single compound or a mixture of compounds that when taken together collectively each have a molecular weight of between 20 and 400 and an overall eRH of the compound or mixture of between 70% and 100% at 20° C. as measured via the eRH test. Without wishing to be bound by theory, an alcohol is any compound comprising at least one OH unit, preferably polyols and diols, more preferably diols. Preferred diols included glycols.

Preferably, the alcohol may be selected from the group comprising ethylene glycol, tetramethylene glycol, pentamethylene glycol, hexamethylene glycol, 2,3-butane diol, 1,3 butanediol, diethylene glycol, triethylene glycol, polyethylene glycol having a molecular weight of less than 6000, glycerol formal, dipropylene glycol, dipropylene glycol methyl ether, propylene glycol monopropyl ether, tripropylene glycol, polypropylene glycol, dipropylene glycol n-butyl ether, and mixtures thereof.

More preferably, the alcohol may be selected from the group comprising ethylene glycol, 2,3-butane diol, 1,3 butanediol, triethylene glycol, polyethylene glycol having a molecular weight of less than 6000, glycerol formal, dipropylene glycol, dipropylene glycol methyl ether, polypropylene glycol, dipropylene glycol n-butyl ether, and mixtures thereof.

Even more preferably the alcohol is selected from the group comprising, dipropylene glycol methyl ether, dipropylene glycol, polypropylene glycol, 2,3-butane diol, dipropylene glycol n-butyl ether and mixtures thereof.

More preferably the alcohol may be selected from the group comprising, dipropylene glycol methyl ether, dipropylene glycol, polypropylene glycol, dipropylene glycol n-butyl ether and mixtures thereof.

Most preferably the alcohol may be selected from the group comprising, polypropylene glycol, dipropylene glycol methyl ether, dipropylene glycol n-butyl ether and mixtures thereof.

One aspect of the present invention is a high active polymer composition suitable for incorporation into a water-soluble unit dose article wherein the high active polymer composition comprises less than 15wt % water, an alcohol, a first polymer and a second polymer, wherein the first polymer is in particulate form, and wherein the second polymer is optionally in particulate form, and wherein the first polymer has an overall anionic charge and comprises an alkali metal ion, an amine, ammonium ion or a mixture thereof, and wherein the second polymer has an overall cationic charge and comprises a halogen ion; wherein the alcohol is selected from the group comprising ethylene glycol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, dipropylene glycol methyl ether, propylene glycol monopropyl ether, tripropylene glycol, polypropylene glycol, dipropylene glycol n-butyl ether, and mixtures thereof, preferably the alcohol is selected from the group comprising dipropylene glycol methyl ether, dipropylene glycol, polypropylene glycol, 2,3-butane diol, dipropylene glycol n-butyl ether and mixtures thereof.

### Water-Soluble Unit Dose Article

The present invention is also to a water-soluble unit dose article comprising a water-soluble film and the high active polymer composition of the present invention. The water-soluble unit dose article comprises at least one water-soluble film shaped such that the unit-dose article comprises at least one internal compartment surrounded by the water-soluble film. The at least one compartment comprises the high active polymer composition. The water-soluble film is sealed such that the high active polymer composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

The high active polymer composition may be combined with one or more further compositions or components before addition to the water-soluble unit dose article.

The unit dose article may comprise between 5% and 20% by weight of the unit dose article of the high active polymer composition.

### Method of Use

The composition or unit dose article of the present invention can be added to a wash liquor to which laundry is already present, or to which laundry is added. It may be used in a washing machine operation and added directly to the drum or to the dispenser drawer. The washing machine may be an automatic or semi-automatic washing machine. It may be used in combination with other laundry detergent compositions such as fabric softeners or stain removers. It may be used as pre-treat composition on a stain prior to being added to a wash liquor.

### EXAMPLES

The viscosity of various compositions was investigated.

The following compositions were prepared;

TABLE 1

| | Weight in grams | | |
|---|---|---|---|
| | Batch 1 | Batch 2 | Batch 3 |
| First composition comprising | 464 | 665.6 | 464 |
| anionic surfactant | | | |
| Second composition containing cationic | 336 | 0 | 0 |
| polymer and anionic polymer and alcohol | | | |
| Cationic polymer | 0 | 53.6 | 53.6 |
| Anionic polymer | 0 | 80.8 | 80.8 |
| Alcohol | 0 | 0 | 201.6 |

The alcohol used was a mix of propylene glycol having a molecular weight of 400 and dipropylene glycol methyl ether.

In batches 2 and 3, a high active polymer composition was not prepared, rather the polymers and/or alcohol were added separately and directly to composition 1.

The compositions were prepared using an IKA EUROSTAR 200 with a 10 cm diameter impeller and mixed at 250 rpm. Ingredients were weighed using a Mettler Toledo PB3002-S.

Viscosity was measured using Rheometer DHR 1 from TA instruments 1 week after batch making. The Rheometer was used following the manufacturer's instructions and set as follows;
1 min equilibration at 0.05 s−1
Flow curve from 0.05 to 1200 mPa·s in 10 min
Temperature: 20 C
Gap: 1000 um

Results can be seen in Table 2;

TABLE 2

| | 1 week after making | | |
|---|---|---|---|
| | 0.5 s−1 | 20 s−1 | 100 s−1 |
| | mPa · s | mPa · s | mPa · s |
| Batch 1 | 7.61 | 2.81 | 2.23 |
| Batch 2 | 12.41 | 3.38 | 4.38 |
| Batch 3 | 11.91 | 5.47 | 3.23 |

As can be seen Batch 1 has a much lower viscosity at all three shear rates recorded. A shear rate of 20 s−1 corresponds to that during pouring of the composition by a consumer and 100 s−1 corresponds to shear rate experienced during manufacture. Batch 1 was formulated in a unit dose article which was stable.

“The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

“While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.”

What is claimed is:

1. A high active polymer composition suitable for incorporation into a water-soluble unit dose article, wherein the high active polymer composition comprises less than about 15wt % water, an alcohol, a first polymer, and a second polymer, wherein the first polymer is in particulate form, wherein the first polymer has an overall anionic charge and comprises an alkali metal ion, an amine, ammonium ion or a mixture thereof, and wherein the second polymer has an overall cationic charge and comprises a halogen ion; wherein the alcohol is selected from the group comprising ethylene glycol, tetramethylene glycol, pentamethylene glycol, hexamethylene glycol, 2,3-butane diol, 1,3 butanediol, diethylene glycol, triethylene glycol, polyethylene glycol having a molecular weight of less than about 6000, glycerol formal, dipropylene glycol, dipropylene glycol methyl ether, propylene glycol monopropyl ether, tripropylene glycol, polypropylene glycol, dipropylene glycol n-butyl ether, and mixtures thereof, wherein the composition has an average particle size distribution d50 of between about 30 um and about 80 um and an average particle size distribution d90 of between about 95 um and about 140 um.

2. The high active polymer composition according to claim 1, wherein the second polymer is in particulate form.

3. The high active polymer composition according to claim 1 wherein the composition has an average particle size distribution d50 between about 40 um and about 60 um.

4. The high active polymer composition according to claim 2 wherein the composition has an average particle size distribution d90 of between about 100 um and about 125 um.

5. The high active polymer composition according to claim 1 wherein the first particle comprises a carrier.

6. The high active polymer composition according to claim 4 wherein the carrier is selected from sulphate, carbonate, clay, starch, sugars, polyethylene glycol having a molecular weight of at least about 800 or a mixture thereof.

7. The high active polymer composition according to claim 4 wherein the polymer is comprised within the carrier, on the carrier, or a mixture thereof.

8. The high active polymer composition according to claim 1 wherein the first polymer, second polymer or both are polysaccharide-based polymers.

9. The high active polymer composition according to claim 1 comprising between about 40% and about 70%, by weight of the composition of the alcohol.

10. The high active polymer composition according to claim 8 comprising between about 50% and about 65% by weight of the composition of the alcohol.

11. The high active polymer composition according to claim lcomprising between about10% and about 30%, by weight of the composition of the second polymer.

12. The high active polymer composition according to claim 10 comprising between about 15% and about 25% by weight of the composition of the second polymer.

13. The high active polymer composition according to claim 1 wherein the weight ratio of the second polymer to the first polymer is between about 1:0.7 and about 1:2.

14. The high active polymer composition according to claim 12 wherein the weight ratio of the second polymer to the first polymer is between about 1:1 to about 1:1.5.

15. The high active polymer composition according to claim 1 wherein the alkali metal ion is selected from potassium, sodium, magnesium or a mixture thereof.

16. The high active polymer composition according to claim 1 wherein the halogen is chloride.

17. A water-soluble unit dose article comprising a water-soluble film and a high active polymer composition according to claim 1.

18. The water-soluble unit dose article according to claim 16 wherein the high active polymer composition is combined with one or more further compositions or components before addition to the water-soluble unit dose article.

19. The water-soluble unit dose article according to claim 16 wherein the water-soluble unit dose article comprises at least two compartments and wherein at least one compartment comprises the high active polymer composition.

20. The water-soluble unit dose article according to claim 16 wherein the unit dose article comprises between about 5% and about 20% by weight of the unit dose article of the high active polymer composition.
